(19) United States
(12) Patent Application Publication
(10) Pub. No.: US 2025/0161950 A1
(43) Pub. Date: May 22, 2025

(54) MICROPLATE HOLDER

(71) Applicant: Andrew Alliance S.A., Canton of Geneva (CH)

(72) Inventor: Giorgio Horak, Genève (CH)

(21) Appl. No.: 18/949,313

(22) Filed: Nov. 15, 2024

Related U.S. Application Data
(60) Provisional application No. 63/600,096, filed on Nov. 17, 2023.
(60) Provisional application No. 63/560,516, filed on Mar. 1, 2024.

(51) Int. Cl. B01L 9/00

(52) U.S. Cl. CPC B01L 9/523; B01L 2200/02; B01L 2200/025; B01L 2300/0858

(57) ABSTRACT

A microplate holder comprises a top shell portion comprising a plurality of holes constructed and arranged to receive a pipette; and a bottom shell portion constructed and arranged to couple to the top shell portion, the top shell portion and the bottom shell portion configured to at least partially enclose a microplate having a plurality of wells vertically aligned with the plurality of holes of the top shell portion, the bottom shell portion having a bottom region that exposes a bottom surface of the microplate to a light generating source that provides backside illumination for a photoactivation process regarding liquid contents of the microplate.

### PRIORITY

The present application claims priority to U.S. Provisional Patent Application No. 63/600,096 filed Nov. 17, 2023 entitled “Microplate Holder,” and U.S. Provisional Patent Application No. 63/560,516 filed Mar. 1, 2024 entitled “Microplate Holder,” the entirety of each of which is incorporated by reference herein.

### BACKGROUND

Multi-well plates, referred to as microplates, are a standard laboratory tool, or labware, used in screening assays, analytical research and diagnostic techniques. They are typically constructed as rectangular trays having an array including rows and columns of wells, which can receive reagents, samples, or other fluids from pipettes or the like.

It is desirable for a microplate to be positioned in a holder that sufficiently protects the reagents, samples, or the like from evaporation and exposure to light or other environmental factors in an ambient environment, while allowing access to analysis equipment such as readers, spectrophotometers, or robotic arms used for analyzing the contents in the wells.

### SUMMARY

In one aspect, the present disclosure describes a microplate holder, comprising: a top shell portion comprising a plurality of holes constructed and arranged to receive a pipette; and a bottom shell portion constructed and arranged to couple to the top shell portion, the top shell portion and the bottom shell portion configured to at least partially enclose a microplate having a plurality of wells vertically aligned with the plurality of holes of the top shell portion, the bottom shell portion having a bottom region that exposes a bottom surface of the microplate to a light generating source that provides backside illumination for a photoactivation process regarding liquid contents of the microplate.

In some embodiments, the microplate holder further comprises a septa mat between the top shell portion and the microplate. In some embodiments, the septa mat includes a plurality of pre-cut septa, each along a vertical axis with a well of the microplate and a hole of the top shell portion.

In some embodiments, the top shell portion includes first and second sidewalls opposite each other, each of the first and second sidewalls having a coupling interface oriented to mate with a corresponding mechanical interface of a gripper of a robotic arm.

In some embodiments, the bottom shell portion includes first and second sidewalls opposite each other, each of the first and second sidewalls having a coupling interface oriented to mate with a corresponding mechanical interface of a liquid handler, lab automation device, shaker, and/or thermal block.

In some embodiments, the bottom shell portion has a first portion have a same length and width as the top shell portion and a second portion has a different length and width for providing a Society for Biomolecular Screening (SBS) compatible footprint.

In some embodiments, the bottom shell portion includes a hard stop for ensuring a vertical alignment of a pipette tip and/or a tube positioned in a well of the microplate.

In some embodiments, the bottom shell portion includes a hard stop for ensuring a vertical alignment of a pipette tip and/or a tube positioned in a well of the microplate.

In some embodiments, the top shell portion and the bottom shell portion each includes a periphery formed of sidewalls of a height for enclosing and blocking the microplate from light, while allowing access to analysis equipment such as readers, spectrophotometers, or robotic arms used for analyzing the contents in the wells.

In another aspect, a microplate holder comprises a top shell portion comprising a plurality of holes constructed and arranged to receive a pipette; and a bottom shell portion constructed and arranged to couple to the top shell portion, the top shell portion and the bottom shell portion configured to at least partially enclose a microplate having a plurality of wells vertically aligned with the plurality of holes of the top shell portion, wherein the bottom shell portion includes a hard stop for ensuring a vertical alignment of a pipette tip and/or a tube positioned in a well of the microplate.

In some embodiments, the microplate holder further comprises a septa mat between the top shell portion and the microplate. In some embodiments, the septa mat includes a plurality of pre-cut septa, each along a vertical axis with a well of the microplate and a hole of the top shell portion.

In some embodiments, the top shell portion includes first and second sidewalls opposite each other, each of the first and second sidewalls having a coupling interface oriented to mate with a corresponding mechanical interface of a gripper of a robotic arm.

In some embodiments, the bottom shell portion includes first and second sidewalls opposite each other, each of the first and second sidewalls having a coupling interface oriented to mate with a corresponding mechanical interface of a liquid handler, lab automation device, shaker, and/or thermal block.

In some embodiments, the bottom shell portion has a first portion have a same length and width as the top shell portion and a second portion having a different length and width for providing a Society for Biomolecular Screening (SBS) compatible footprint.

In some embodiments, the top shell portion and the bottom shell portion each includes a periphery formed of sidewalls of a height for enclosing and blocking the microplate from light, while allowing access to analysis equipment such as readers, spectrophotometers, or robotic arms used for analyzing the contents in the wells.

In another aspect, a microplate holder comprises a top shell portion comprising a plurality of holes constructed and arranged to receive a pipette; and a bottom shell portion constructed and arranged to couple to the top shell portion, the top shell portion and the bottom shell portion configured to at least partially enclose a microplate having a plurality of wells vertically aligned with the plurality of holes of the top shell portion, wherein the top shell portion and the bottom shell portion each includes a periphery formed of sidewalls of a height for enclosing and blocking the microplate from light, while allowing access to analysis equipment such as readers, spectrophotometers, or robotic arms used for analyzing the contents in the wells, and the bottom shell portion.

In some embodiments, the microplate holder further comprises a coupling mechanism for coupling the bottom shell portion and the top shell portion to protect the microplate from light or other ambient environment condition.

In some embodiments, the bottom shell portion includes a hard stop for ensuring a vertical alignment of a pipette tip and/or a tube positioned in a well of the microplate.

In some embodiments, the microplate holder further comprises a septa mat between the top shell portion and the microplate.

### BRIEF DESCRIPTION OF THE DRAWINGS

FIG. 1 depicts an exploded view of a microplate holder assembly, in accordance with an embodiment.

FIG. 2 depicts an assembled view of the microplate holder assembly of FIG. 1.

FIG. 3 depicts a perspective view of a pre-cut septa and top shell portion of the microplate holder assembly of FIGS. 1 and 2.

FIG. 4 depicts a perspective view of the pre-cut septa coupled to the top shell portion of the microplate holder assembly of FIGS. 1-3.

FIG. 5 depicts a perspective view of the bottom shell portion of the microplate holder assembly of FIGS. 1 and 2.

FIG. 6 depicts a perspective view of a microplate positioned in the bottom shell portion of the microplate holder assembly of FIGS. 1-5.

FIG. 7 depicts a top view of the microplate holder assembly of FIGS. 1-6.

FIG. 7A depicts a cutaway view of the microplate holder assembly of FIG. 7, taken along line 7-7 of FIG. 7.

FIGS. 7B and 7C depict other various views of the microplate holder assembly of FIG. 7.

FIG. 8 depicts a perspective view of the microplate holder assembly of FIGS. 1-7 engaged with a robotic gripper.

FIGS. 9-11B depict various perspective, front, side, and cross-section views of a coupling mechanism of a microplate holder assembly, in accordance with another embodiment.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, embodiments and examples disclosed herein are directed to a microplate holder assembly that may be used for the storing, processing, and/or analyzing chemical, biological and/or physical samples, and for allowing assays to be executed. The microplate holder assembly is constructed to allow researchers to perform manual operations, and/or to be used in a laboratory automation environment. For example, an evaluation workflow process of an assay, for example, for detecting DNA or testing pathogens may include automation steps related to the transfer of a sample into vials or tubes arranged in wells of a microplate and detection operations performed on the samples.

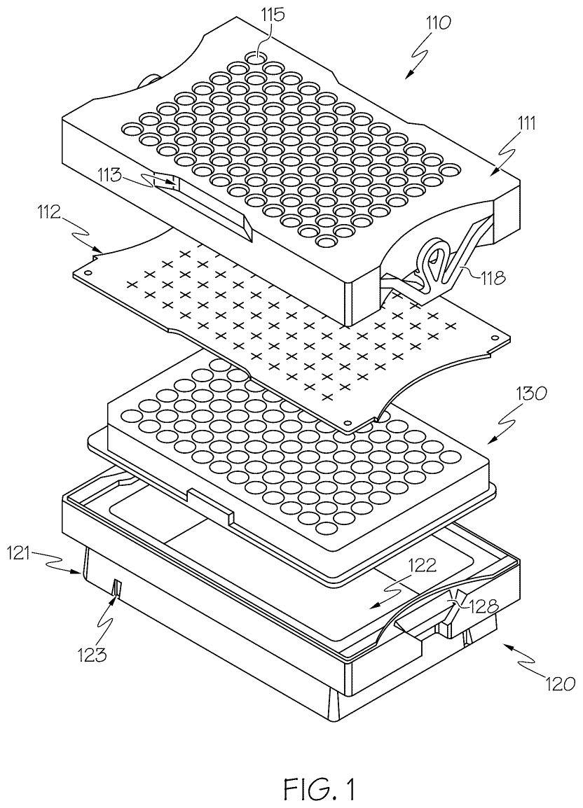

Referring to FIG. 1, embodiments of a microplate holder assembly 100 include a top shell portion 110 and a bottom shell portion 120 that are constructed and arranged to removably couple to each other, and in doing so can host, or some or entirely cover or encapsulate, a microplate 130 and its liquid contents. In some embodiments, the top shell portion 110 and a bottom shell portion 120 are constructed and arranged in a clamshell configuration for holding the microplate 130. When removed, at least the top shell portion 110 can be cleaned by a cleaning agent such as ethanol or inserted into a cleaning apparatus such as an autoclave.

In some embodiments, the top shell portion 110 includes an embedded pre-cut septa 112 compatible with pipettes to minimize evaporation of the liquid present in the wells of the microplate. In other embodiments, as shown, the pre-cut septa 112 is coupled to the bottom region of the top shell portion 110. The septa 112 may be in the form of a septa mat that forms a tight seal across the wells of the microplate 130, for example, a 96-well plate, while allowing easy sample access through the septa, which may be pre-cut or pierceable.

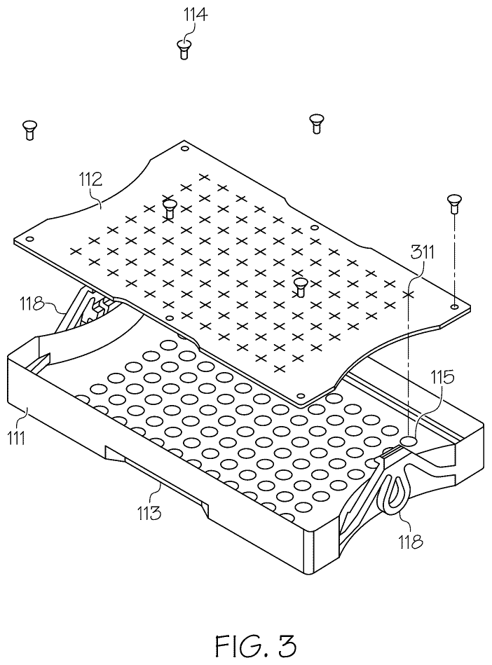

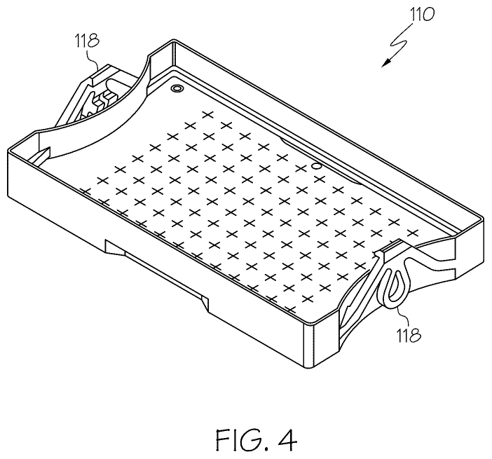

As shown in FIGS. 3 and 4, the pre-cut septa 112 can be coupled to an interior surface of the top shell portion 110, for example, using threaded screws 114 but not limited thereto. Adhesives, clamps, or other coupling mechanisms may equally apply. As shown in FIG. 3, the septa 112 is coupled to or otherwise integrated with the top shell portion 110 so that the cuts 311 of the septa 112 are vertically aligned with the holes 115 in the top shell body 111. The holes 115 provide openings via the septa 112, which are in the interior of the top shell body 111 and below the top surface of the top shell body 111. In doing so, the internal volume of the holder 10 is accessible through the septa 112 below the corresponding openings 115 of the top shell portion, for example, via a syringe or pipette. Here, sample material can be introduced to or removed from the vessels in the microplate. The septa 112 at the top shell portion 110 is constructed and arranged to allow the penetration of a pipette tip through each hole (see FIG. 3) in the top shell portion 110, for example, by a human or robot, which can minimize possible liquid evaporation or liquid escaping and splashing, for example, during a mixing operation. The pre-cut septa 112 is compatible with plastic pipette tips to minimize evaporation of the liquid present in the labware 130, e.g., microplate, deep-well plate, PCR plates, and the like. When the top shell portion 110 is separated from the bottom shell portion 120, at least the top shell portion 110 including the septa 112 can be cleaned by a cleaning agent such as ethanol or inserted into a cleaning apparatus such as an autoclave. In other embodiments, the septa 112 is removed from the top shell body 111 prior to cleaning the top shell portion 110.

The top shell portion 110 is also constructed and arranged to protect the samples positioned in the holder from environmental light. In particular, the top shell portion 110 includes sidewalls and ends that form an interior region which can be positioned over at least a top portion of a microplate including wells or the like where samples are provided. This region is covered by the top shell portion 110 which is formed of materials such as plastic that protect the samples in the microplate from environmental light.

In some embodiments, at least one of the sidewalls of the top shell portion 110 is constructed to engage with a gripper of a robotic arm or other mechanical apparatus configured for transferring the holder 10 between different locations, e.g., for an automated transfer of the holder 10. For example, as shown in FIG. 8, the holder 10 includes two cutout, notches, or related coupling interfaces 113 on opposite sides of the top shell portion 110 oriented to mate with a corresponding mechanical interface of a microplate gripper 12 of a robotic arm or the like.

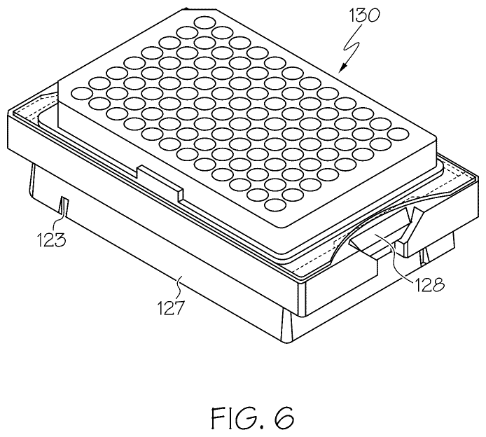

The bottom shell portion 120 includes a bottom shell body 121 having a groove 118 or related coupling mechanism constructed and arranged to couple to the top shell 110 to allow an incubation of the microplate contents, e.g., samples, etc. in darkness. In some embodiments, the bottom shell body 121 is constructed to comply with industry standards, for example, ANSI SLAS 1-2004 (R2012). In some embodiments, the top shell portion 110 may having tabs, latches, or other related male coupling components 118 that extend from respective ends of the top shell body 111. In particular, the coupling components 118 may extend vertically from the top shell body 111 for mating with a cavity, groove, or other female coupling component 128 of the bottom shell body 121. The coupling components 118, 128 of the top shell body 111 and bottom shell body 121, respectively, may had a shape or configuration that permits a locking mechanism to be formed of the coupling components 118, 128 that holds the top shell body 111 and bottom shell body 121 in place relative to each other when housing a microplate 130 sandwiched therebetween. A human or automated source such as a robotic apparatus may apply a reasonable force to separate the coupling components 118, 128, and therefore the top shell body 111 and bottom shell body 121 from one another to remove or insert a microplate into the bottom shell portion 120, for example, shown in FIG. 6.

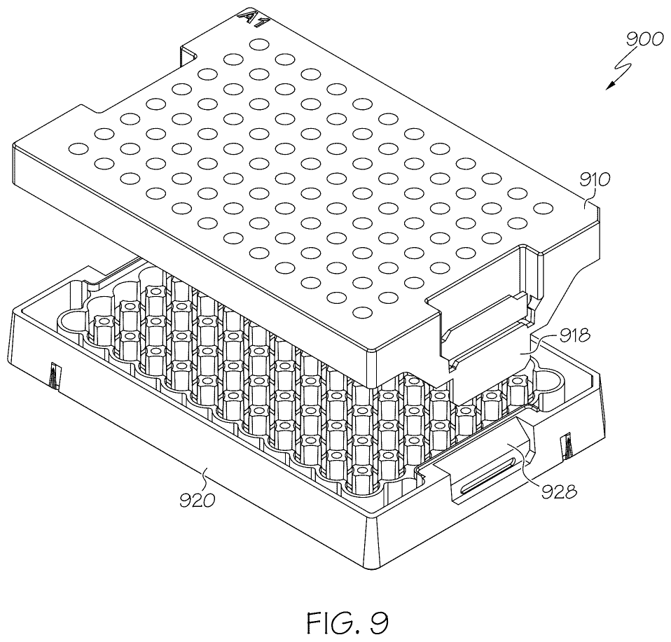

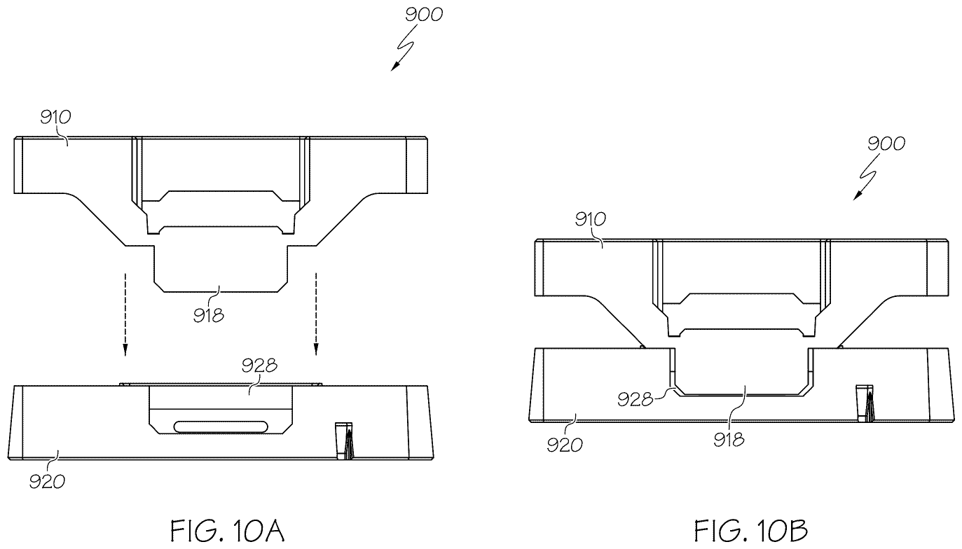

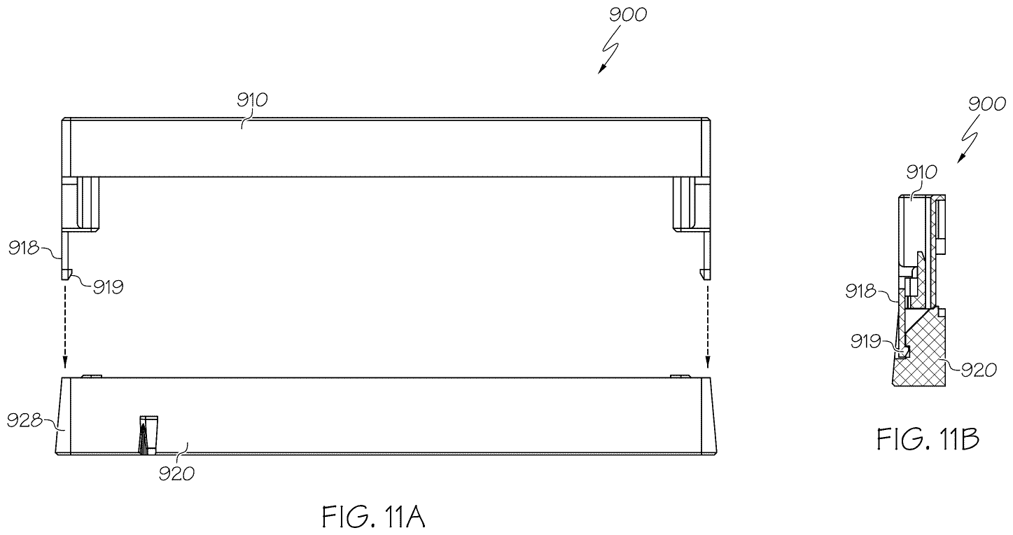

FIGS. 9-11B include various views of a coupling mechanism of a microplate holder assembly 900 including coupling components 918, 919, and 928 for coupling a top shell 910 and bottom shell portion 920. Other details of the microplate holder assembly 900 of FIGS. 9-11B are similar to those in the embodiments described in FIGS. 1-8 and are not repeated for brevity.

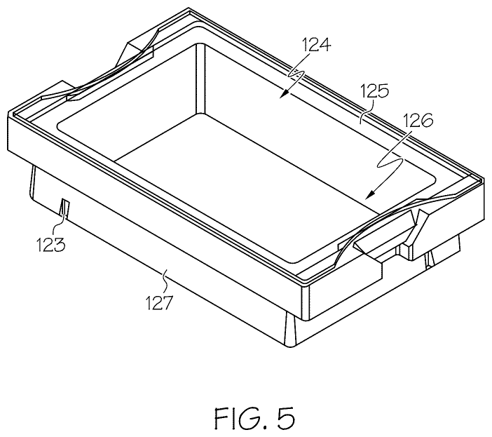

Referring again to the microplate holder assembly 10 of FIGS. 1-8, the bottom portion 120 includes an open interior region 124 to expose labware such as the microplate 130 between the two shells 111, 121 to back illumination from analysis equipment. In some embodiments, the open interior region 124 includes a shelf or ridge 125 about the periphery of the interior region 124 formed by the sidewalls and ends of the bottom shell body 121. The shelf or ridge 125 is constructed and arranged for receiving a microplate 130. Referring again to FIGS. 5 and 6, the plate labware 130 may have holes, wells, or the like where tubes, vials, etc. can be inserted such that bottom portions of the vials, tubes, etc. may extend vertically beyond a height of the shelf or ridge 125 and into a region 126 of the interior region 124 that is below the shelf or ridge. In other embodiments, the microplate 130 has a bottom surface that does not permit objects such as vials, etc. to extend beyond the bottom surface, and provides a hard stop. Here, the bottom surface of the microplate 130 abuts the shelf or ridge 125 of the bottom shell body 121 and the lower inner region 126 is devoid of any objects extending from the microplate 130.

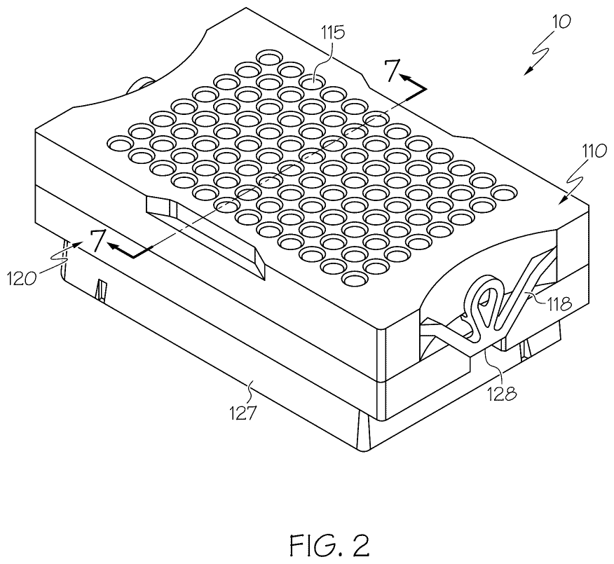

As shown in FIG. 2, the holder 10 when assembled, i.e., the top portion 110 is coupled to the bottom portion 120 and the microplate holder 130 is sandwiched between the top portion 110 and the bottom portion 120, the holder 10 sufficiently protects the reagents, samples, or the like from evaporation and exposure to light or other environmental factors in an ambient environment, while allowing access to analysis equipment such as readers, spectrophotometers, or robotic arms used for analyzing the contents in the wells. For example, where the top portion 110 includes a septa 112 (shown in FIG. 4, and the bottom portion 120 is open, the two portions when closed or clamped together blocks light about the top and sides of the microplate 130. In some embodiments, as described below, the bottom side of the microplate 130 may be exposed to a light emitting diodes (LED) array that provides backside illumination, e.g., for photoactivation processes.

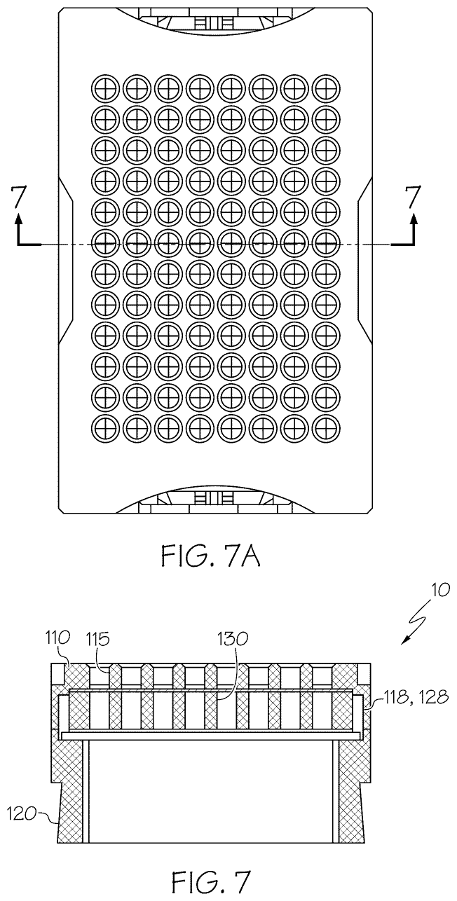

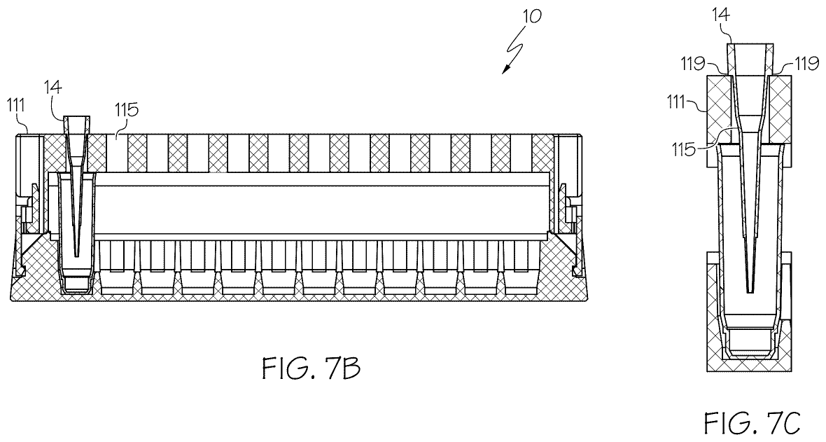

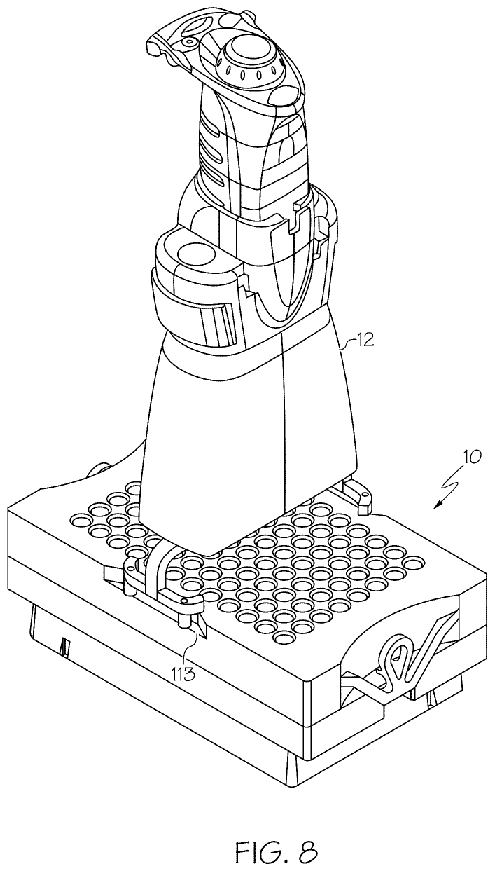

As shown in FIGS. 7-7C, the holder 10 can host PCR tubes 14 or the like, which are part of a container 130 such a microplate or the like, e.g., a 96-well PCR microplate, sandwiched between the top shell portion 110 and the bottom shell portion 120, which provide a precise vertical position of a pipette tip. In some embodiments, as shown in FIGS. 7B and 7C, the hard stop 119 and corresponding interfaces are located in the top shell body 111. In particular, the microplate 130 has a series of wells, tubes, or the like each intended to receive a chemical or biological solution to be analyzed. The microplate 130 may further comprise a pipette for transferring biological material to and from one or more wells of the microplate 130. The wells, tubes, or the like have an open end which is vertically aligned with the holes 115 in the top shell body 111, so that a vertical path or channel is formed for a pipette or the like. The pipette has an open tip for drawing and dispensing the biological material through the pre-cut septa 112 and hole 115. As shown in FIG. 7, the holder 10 has an interface between the top shell body 111 and the pipette tip. This configuration holds the PCR tube(s) in place during liquid handling operations such as aspiration and dispensing by the pipette 14 and provides a precise vertical location.

As also shown in FIG. 5, the interior region 124 of the bottom shell portion 120 is “open” such that the shown by the lower inner region 126 which extends through the vertical length of the bottom shell body 121 to allow a backside illumination, e.g., for photoactivation processes, which may be used on a microplate 130, such as a clear-bottom microplate. In other words, the top surface of the microplate can be enclosed so as to be protected from light, while the bottom surface of the microplate can be exposed to light. A system may include a combination of electronics comprising light emitting diodes (LEDs) or other light emitting devices that form an illumination panel that can expose the samples located in the microplate 130 to light. For example, the light system can provide a photoactivation of enzymes or other particles in a solution located in the wells, tubes, vials, etc. positioned above the bottom shell portion 120, for example, shown in FIG. 6. In other embodiments, the bottom region of the bottom shell portion 120 can be covered, for example, when the bottom shell portion 120 is positioned on a flat surface where incubation or other operations can be performed in a dark environment.

The bottom shell portion 120 has a bottom section 127 that has a periphery that is smaller than the periphery of the top section 125 forming the shelf or ridge. The top section 125 of the bottom shell portion may have a same dimension, e.g., same peripheral, width, length, and so on, as the top shell portion 110, for example, as shown in FIG. 2. The top section 125 and the bottom section 127 collectively form the interior 124, 126. This configuration allows the bottom section 127 to be positioned in an enclosure of an LED array that provides backside illumination, e.g., for photoactivation processes. The ridge of the top portion 125 can rest on the top surface of the enclosure while the bottom portion 127 is positioned in the enclosure. Other applications and uses for the two different dimensions (width, length) of the top portion 125 and bottom portion 127 may equally apply.

In some embodiments, the bottom portion 127 includes one or more mechanical interfaces 123, such as a cutout or notch, oriented to mate with a corresponding mechanical interface, e.g., a radially inwardly extending protrusion or detent disposed on a standard liquid handler, lab automation device, shaker, and/or thermal block to lock the bottom shell portion 120 to the standard liquid handler, lab automation device, shaker, and/or thermal block. In some embodiments, the bottom shell portion 120, in particular, the bottom section 127 has a footprint that is compatible for an SBS (Society for Biomolecular Screening) format to allow compatibility with standard liquid handlers, lab automation devices, and/or thermal blocks. For example, thermal blocks may provide for a heat transfer to the labware that occurs through the bottom shell's open design, allowing direct contact between the labware's base and a metallic thermal block. This setup facilitates efficient thermal conduction, suitable for placement on heating devices or Peltier modules for precise temperature control.

What is claimed is:

1. A microplate holder, comprising:
a top shell portion comprising a plurality of holes constructed and arranged to receive a pipette; and
a bottom shell portion constructed and arranged to couple to the top shell portion, the top shell portion and the bottom shell portion configured to at least partially enclose a microplate having a plurality of wells vertically aligned with the plurality of holes of the top shell portion, the bottom shell portion having a bottom region that exposes a bottom surface of the microplate to a light generating source that provides backside illumination for a photoactivation process regarding liquid contents of the microplate.

2. The microplate holder of claim 1, further comprising a septa mat between the top shell portion and the microplate.

3. The microplate holder of claim 2, wherein the septa mat includes a plurality of pre-cut septa, each along a vertical axis with a well of the microplate and a hole of the top shell portion.

4. The microplate holder of claim 1, wherein the top shell portion includes first and second sidewalls opposite each other, each of the first and second sidewalls having a coupling interface oriented to mate with a corresponding mechanical interface of a gripper of a robotic arm.

5. The microplate holder of claim 1, wherein the bottom shell portion includes first and second sidewalls opposite each other, each of the first and second sidewalls having a coupling interface oriented to mate with a corresponding mechanical interface of a liquid handler, lab automation device, shaker, and/or thermal block.

6. The microplate holder of claim 1, wherein the bottom shell portion has a first portion have a same length and width as the top shell portion and a second portion having a different length and width for providing a Society for Biomolecular Screening (SBS) compatible footprint.

7. The microplate holder of claim 1, further comprising a coupling mechanism for coupling the bottom shell portion and the top shell portion to protect the microplate from light or other ambient environment condition.

8. The microplate holder of claim 1, wherein the bottom shell portion includes a hard stop for ensuring a vertical alignment of a pipette tip and/or a tube positioned in a well of the microplate.

9. The microplate holder of claim 1, wherein the top shell portion and the bottom shell portion each includes a periphery formed of sidewalls of a height for enclosing and blocking the microplate from light, while allowing access to analysis equipment such as readers, spectrophotometers, or robotic arms used for analyzing the contents in the wells.

10. A microplate holder, comprising:
a top shell portion comprising a plurality of holes constructed and arranged to receive a pipette; and
a bottom shell portion constructed and arranged to couple to the top shell portion, the top shell portion and the bottom shell portion configured to at least partially enclose a microplate having a plurality of wells vertically aligned with the plurality of holes of the top shell portion, wherein the bottom shell portion includes a hard stop for ensuring a vertical alignment of a pipette tip and/or a tube positioned in a well of the microplate.

11. The microplate holder of claim 10, further comprising a septa mat between the top shell portion and the microplate.

12. The microplate holder of claim 11, wherein the septa mat includes a plurality of pre-cut septa, each along a vertical axis with a well of the microplate and a hole of the top shell portion.

13. The microplate holder of claim 10, wherein the top shell portion includes first and second sidewalls opposite each other, each of the first and second sidewalls having a coupling interface oriented to mate with a corresponding mechanical interface of a gripper of a robotic arm.

14. The microplate holder of claim 10, wherein the bottom shell portion includes first and second sidewalls opposite each other, each of the first and second sidewalls having a coupling interface oriented to mate with a corresponding mechanical interface of a liquid handler, lab automation device, shaker, and/or thermal block.

15. The microplate holder of claim 10, wherein the bottom shell portion has a first portion have a same length and width as the top shell portion and a second portion having a different length and width for providing a Society for Biomolecular Screening (SBS) compatible footprint.

16. The microplate holder of claim 10, wherein the top shell portion and the bottom shell portion each includes a periphery formed of sidewalls of a height for enclosing and blocking the microplate from light, while allowing access to analysis equipment such as readers, spectrophotometers, or robotic arms used for analyzing the contents in the wells.

17. A microplate holder, comprising:
a top shell portion comprising a plurality of holes constructed and arranged to receive a pipette; and
a bottom shell portion constructed and arranged to couple to the top shell portion, the top shell portion and the bottom shell portion configured to at least partially enclose a microplate having a plurality of wells vertically aligned with the plurality of holes of the top shell portion, wherein the top shell portion and the bottom shell portion each includes a periphery formed of sidewalls of a height for enclosing and blocking the microplate from light, while allowing access to analysis equipment such as readers, spectrophotometers, or robotic arms used for analyzing the contents in the wells, and the bottom shell portion.

18. The microplate holder of claim 17, further comprising a coupling mechanism for coupling the bottom shell portion and the top shell portion to protect the microplate from light or other ambient environment condition.

19. The microplate holder of claim 17, wherein the bottom shell portion includes a hard stop for ensuring a vertical alignment of a pipette tip and/or a tube positioned in a well of the microplate.

20. The microplate holder of claim 17, further comprising a septa mat between the top shell portion and the microplate.
